(19) United States
(12) Patent Application Publication
(10) Pub. No.: US 2008/0297365 A1
(43) Pub. Date: Dec. 4, 2008

(54) Method and system of guising communication using a chatter signal

(75) Inventors: Devon Welles, Hillsboro, CA (US); Chris Gough, Portland, OR (US); Chris Vondrachek, Hillsboro, OR (US); Lewis Adams, Carmel, CA (US)

Correspondence Address: MURABITO, HAO & BARNES, LLP, TWO NORTH MARKET STREET, THIRD FLOOR, SAN JOSE, CA, 95113, US

(73) Assignee: Gainspan, Inc.

(21) Appl. No.: 11/809,012

(22) Filed: May 30, 2007

(51) Int. Cl. H04B 7/24; G08B 21/00; H04K 1/02

(52) U.S. Cl. 340/670; 455/39; 380/252

(57) ABSTRACT

Method and system of guising communication using a chatter signal is disclosed. In one embodiment, a method includes communicating a chatter signal generated by a first node of a network to a second node based on the communication protocol of the network to guise a true signal of the first node communicated to the second node of the network, and processing the true signal communicated to the second node while dispensing with the chatter signal communicated to the second node based on the communication protocol of the network. The method may also include padding the chatter signal and/or the true signal with pseudorandom bits to make a size of the chatter signal equal to a size of the true signal. Moreover, the method may include guising a key exchanged between the first node and the second node with the chatter signal.

### FIELD OF TECHNOLOGY

This disclosure relates generally to technical fields of software and/or hardware and, in one embodiment, to method and system of guising communication using a chatter signal.

### BACKGROUND

A motion sensor may be used for purposes of security and home automation. A hard-wired motion sensor may be connected to a device it controls or into a circuit in a house. However, a security of the hard-wired motion sensor may be jeopardized when a trespasser taps into a wiring connecting the hard-wired motion sensor and the house. Furthermore, the wiring may add an extra cost to the security and home automation and/or esthetically unattractive.

A wireless motion sensor may be used to communicate wirelessly with another wireless sensor and/or a control point, especially when a motion in the house is detected. Signals (e.g., indicating the motion in the house) of the wireless motion sensor may be easily listened in when the signals are not encrypted. Even if the signals are encrypted, the signals (e.g., sent out from the wireless motion sensor) may indicate that the wireless motion sensor is detecting a motion or a presence, thus making it susceptible to eavesdropping.

### SUMMARY

Method and system of guising communication using a chatter signal is disclosed. In one aspect, a method includes communicating a chatter signal (e.g., which may be encrypted pseudorandom bits to be decrypted by the second node based on a communication protocol) generated by a first node (e.g., a wireless and/or wired device) of a network to a second node (e.g., a control point managing the device) based on the communication protocol of the network to guise a true signal of the first node communicated to the second node of the network, and processing the true signal communicated to the second node while dispensing with the chatter signal communicated to the second node based on the communication protocol of the network.

The method may also include guising a heartbeat signal of the device communicated to the control point with the chatter signal (e.g., where the true signal may be the heartbeat signal of the device communicated to the control point indicating that the device is ready to communicate with the control point). The method may further include guising a signal data (e.g., the signal data is a configuration data to set up the device and/or a command data to initiate an action by the device) of the control point to the device (e.g., which may include a low power wireless system on chip (SOC) having a real time counter module communicatively coupled to the device to generate the true signal and/or the chatter signal to minimize a power consumption of the system on chip) with the chatter signal.

In addition, the method may include padding the chatter signal and/or the true signal with pseudorandom bits to make a size of the chatter signal equal to a size of the true signal. Also, a random number of bits may be added to the chatter signal and/or the true signal such that the size of the chatter signal and the size of the true signal are random. Moreover, the method may include guising a key exchanged between the first node and the second node with the chatter signal (e.g., where the true signal may convey the key exchanged between the first node and the second node preceding a secure communication between the first node and the second node).

In another aspect, a method includes monitoring a motion using a wireless motion sensor (e.g., which may be locally controlled by a low power wireless system on chip (SOC) having a real time counter module communicatively coupled to the wireless motion sensor to periodically generate a true signal and/or a chatter signal to minimize a power consumption of the system on chip) to generate an activity signal when the motion is detected by the wireless motion sensor and communicating the chatter signal (e.g., periodic and/or aperiodic) to disguise the activity signal communicated to a control point managing the wireless motion sensor through a wireless network.

The method may also include padding the chatter signal and/or the activity signal with pseudorandom bits such that the chatter signal may not be recognizable from the activity signal based on a size difference between the chatter signal and the activity signal. The method may further include encrypting the chatter signal and/or the activity signal prior to communicating the chatter signal and the activity signal to the control point. Additionally, the method may include dispensing with the chatter signal when the control point decrypts the activity signal and/or the chatter signal to process the activity signal.

In yet another aspect, a first node (e.g., a device) of a network to generate one or more chatter signals with a true signal to disguise the true signal and a second node (e.g., a control point managing the device through a network) to communicate with the first node through processing the true signal while dispensing with the one or more chatter signals.

The system may also include a low power wireless system on chip (SOC) having a real time counter module communicatively coupled to the device to periodically generate the true signal and/or the one or more chatter signals to minimize a power consumption of the system on chip. In addition, the first node of the system may be a device newly installed to the network and the second node may be an authentication server to authenticate the device based on the true signal which may be an authentication request of the device communicated to the authentication server.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network view of a low power system on chip interacting with a controller and/or a number of external devices, according to one embodiment.

FIG. 2 is a schematic diagram of a low power wireless system on chip (SOC) having a real time counter module islanded from the rest of the low power system on chip, according to one embodiment.

FIG. 3 is an interaction diagram of software modules of the low power wireless SOC of FIG. 2, according to one embodiment.

FIG. 4 is a state diagram of the low power wireless SOC of FIG. 2, according to one embodiment.

FIG. 5 is a low power wireless system on chip interacting with a host server through an access point, according to one embodiment.

FIG. 6 is a state flow diagram of disguising an activity signal of a wireless motion sensor with one or more chatter signals, according to one embodiment.

FIG. 7 is a diagrammatic system view 700 of a data processing system in which any of the embodiments disclosed herein may be performed, according to one embodiment.

Other features of the present embodiments will be apparent from the accompanying drawings and from the detailed description that follows.

### DETAILED DESCRIPTION

Method and system of guising communication using a chatter signal is disclosed. In the following description, for purposes of explanation, numerous specific details are set forth in order to provide a thorough understanding of the various embodiments. It will be evident, however, to one skilled in the art that the various embodiments may be practiced without these specific details.

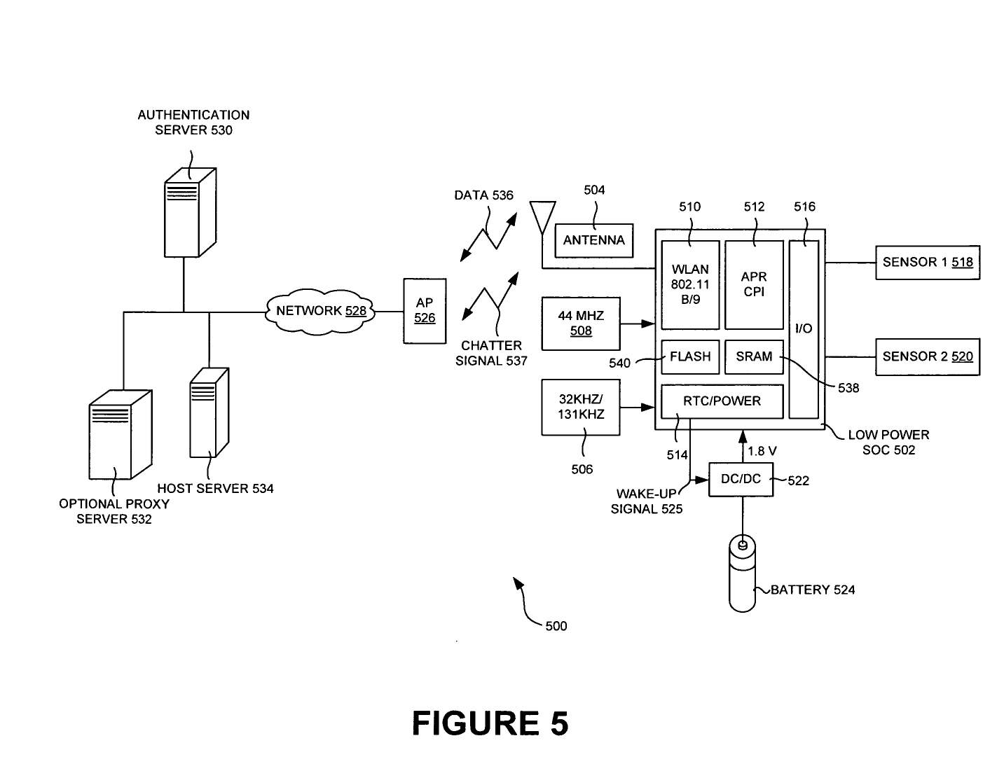

In one embodiment, a method includes communicating a chatter signal (e.g., a chatter signal 538 of FIG. 5) generated by a first node (e.g., a sensor 1 518, a sensor 2 520) of a network (e.g., a network 528) to a second node (e.g., a host server 534) based on a communication protocol of the network to guise a true signal (e.g., a true signal 538) of the fist node communicated to the second node of the network, and processing the true signal communicated to the second node while dispensing with the chatter signal communicated to the second node based on the communication protocol of the network.

In another embodiment, a method includes monitoring a motion using a wireless motion sensor (e.g., the sensor 1 518, the sensor 2 520, etc.) to generate an activity signal (e.g., the true signal 536) when the motion is detected by the wireless motion sensor and communicating the chatter signal (e.g., the chatter signal 536) to disguise the activity signal communicated to a control point managing the wireless motion sensor through a wireless network.

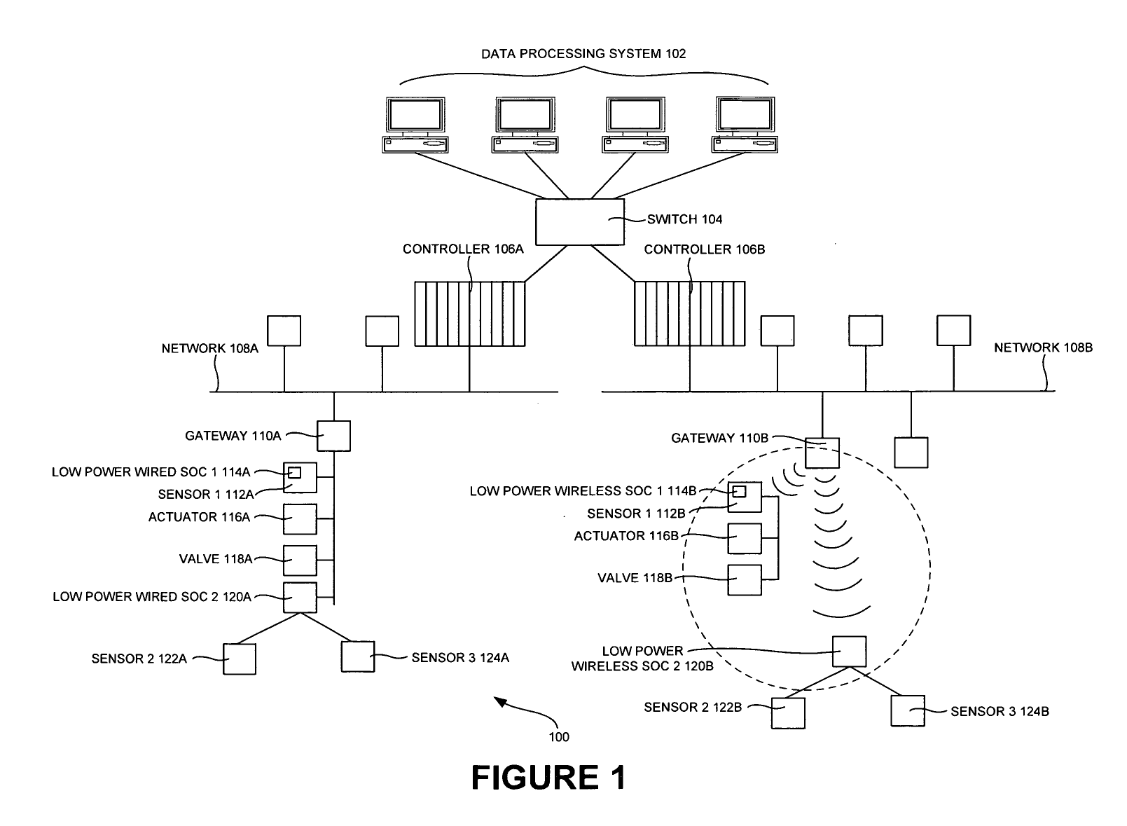

In yet another embodiment, a first node (e.g., a sensor 1 112, a sensor 2 122, and/or a sensor 3 124 of FIG. 1) of a network (e.g., the network 108) to generate one or more chatter signals with a true signal to disguise the true signal and a second node (e.g., a controller 106) to communicate with the first node through processing the true signal while dispensing with the one or more chatter signals.

FIG. 1 is a network view of a low power system on chip 114 interacting with a controller 106 and/or a number of external devices, according to one embodiment. A low power system on chip (SOC) 1 114 (e.g., a low power wired SOC 1 114A and/or a low power wireless SOC 1 114B) embedded in a sensor 112 may connect the number of external devices (e.g., a sensor 1 112, an actuator 116, a valve 118, etc.) to a gateway 110 (e.g., an access point). The gateway 110 may be connected to a network 108 (e.g., a WAN, a LAN, a WLAN, the internet etc.) which may in turn be connected to other gateways communicating with other devices.

A low power SOC 120 (e.g., a low power wired SOC 2 120A and/or a low power wireless SOC 2 120B) may also externally control a sensor (e.g., a sensor 2 122 and/or a sensor 3 124). The network 108 (e.g., the network 108A and/or the network 108B) may be connected to the controller 106 (e.g., the controller 106A and/or the controller 106B) which may be used to control a transmission of data over the network 108, the devices, and/or a switch 104 (e.g., which may be used to regulate the transmission of data between a data processing system 102 and/or the controller 106).

In one example embodiment, a first node (e.g., the sensor 1 112 embedded in the low power wireless SOC 1 114, the sensor 2 122 and the sensor 3 124 externally coupled to the low power wireless SOC 2 120, etc.) of a network (e.g., the network 108) may generate with one or more chatter signals (e.g., pseudorandom bits) with a true signal (e.g., carrying data) to disguise the true signal. A second node (e.g., the controller 106, a control point having an algorithm to manage the first node, etc.) may communicate with the first node through processing the true signal while dispensing with the one or more chatter signals.

In another example embodiment, the first node may be a new device (e.g., the sensor 1 112 embedded in the low power wireless SOC 1 114, the sensor 2 122 and the sensor 3 124 externally coupled to the low power wireless SOC 2 120, etc.) installed to the network (e.g., the network 108) and the second node may be an authentication server (e.g., an authentication sever 530 of FIG. 5) to authenticate the device based on the true signal which is an authentication request of the device communicated to the authentication server.

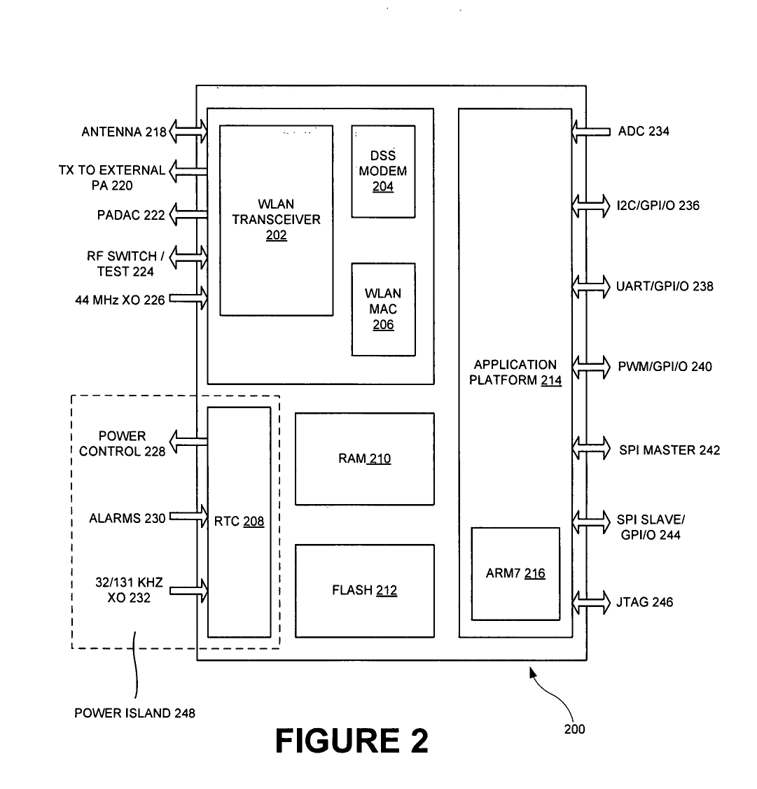

FIG. 2 is a schematic diagram of a low power wireless system on chip (SOC) 200 having a real time counter module 208 islanded from the rest of the system on chip, according to one embodiment. The low power wireless SOC 200 includes a dual-processor system (e.g., ARM7 216 based) with a direct-sequence spread spectrum (DSSS) Modem 204 (e.g., an IEEE 802.11b) and a WLAN transceiver 202 in a single chip. The low power wireless SOC 200 may be used by a wireless facility to monitor environmental conditions (e.g., a temperature, an occupancy, a humidity, a radiation, a vibration, a pressure, etc.).

In one example embodiment, the low power wireless SOC 200 may have a 2.4 GHz complementary metal-oxide-semiconductor (CMOS) WLAN transceiver 202, which may have an embedded power amplifier (PA) with a programmable output power (e.g., up to 12 dBm). The PA output may be merged with low-noise amplifier (LNA) inputs. The direct-sequence spread spectrum (DSSS) modem 204 may modulate for data rates (e.g., 1 Mb/s and/or 2 Mb/s). A transmitted signal of the DSSS modem 204 mat take up more bandwidth than the information signal that is being modulated (e.g., where the name ‘spread-spectrum’ comes from the fact that the carrier signals occur over the full bandwidth (spectrum) of a device's transmitting frequency).

The DSSS modem may multiply the data being transmitted by a noise signal, which is a pseudorandom sequence of 1 and −1 values, at a frequency much higher than that of the original signal, thereby spreading the energy of the original signal into a much wider band. The resulting signal may resemble a white noise, except that the resulting signal may be filtered out at the receiving end to recover the original signal by multiplying the same pseudorandom sequence to the received signal (because 1×1=1, and −1×−1=1).

As shown in FIG. 2, the low power wireless SOC 200 may have a WLAN medium access control (MAC) 206, which may provide addressing and channel access control mechanisms that may make it possible for several terminals and/or network nodes to communicate with the WLAN transceiver 202. The MAC data communication protocol sub-layer may be a part of the seven-layer OSI model data link layer (layer 2). The MAC sub-layer may act as an interface between the Logical Link Control sub-layer and the network's physical layer. The MAC layer may provide an addressing mechanism called physical address or MAC address (e.g., a unique serial number which may be assigned to each network adapter, making it possible to deliver data packets to a destination within a sub-network, which may be a physical network without routers, e.g., an Ethernet LAN, WLAN, etc.). The low power system on low power wireless SOC 200 may include high-throughput hardware with two small private random access memories (RAM) for encryption/decryption, hardware co-processing for demanding lower-MAC tasks and hardware support of IEEE 802.11i, (e.g., Counter Mode with Cipher Block Chaining Message Authentication Code Protocol (CCMP), which is a full security IEEE 802.11i encryption protocol).

The application platform (APP) 214 may be a dual processor platform which may include two ARM7 216, one to run the WLAN software and the other to run the application software, running at specified frequency (e.g., 11, 22, 44 MHz). The ARM architecture may be a 32-bit reduced instruction set computer (RISC) architecture that may widely be used in a number of embedded designs. Due to their power saving features, ARM central processing units (CPU) are dominant in the mobile electronics market, where low power consumption is a critical design goal. The APP may be based on two separated AMBA high performance busses (AHB) to maximize the bandwidth allowed to each CPU (e.g., to avoid time-sharing when using the bus so that both CPUs are fully operational at all times). The CPUs may also be equipped with Joint Test Action Group (JTAG) test access ports 246 for hardware debug purposes.

The low power wireless SOC 200 may include a random access memory (RAM) 210 including a shared memory of 192K bytes for both CPUs and dedicated RAM of 32K bytes for the WLAN CPU. The shared RAM may be mainly used by the APP CPU and may contain the data frames for inter-CPU communication. However, the shared RAM may also be used by the WLAN CPU during software update procedures and for future extensions of the WLAN stack if feasible. As illustrated in FIG. 2 the low power wireless SOC 200 also may have 384K bytes of embedded Flash memory 212 which may be used to update the firmware. The on-chip start-up code may be located in a dedicated boot ROM which may be divided for the use of each CPU.

FIG. 2 also illustrates a Real Time Clock (RTC) 208 which may provide global time and/or date to the low power wireless SOC 200. The RTC 208 may contain a low-power crystal oscillator that may support a 32.768 kHz crystal and/or a 131.072 kHz crystal 232. The RTC 208 may run on a dedicated power supply, ranging between 1.2V and 3.6V. Three programmable wrap-around alarm counters may be provided to enable periodic wake-up of the low power wireless SOC 200 and two independent external components. Two alarm inputs 230 (e.g., external) may enable wake-up of the low power wireless SOC 200 on external events.

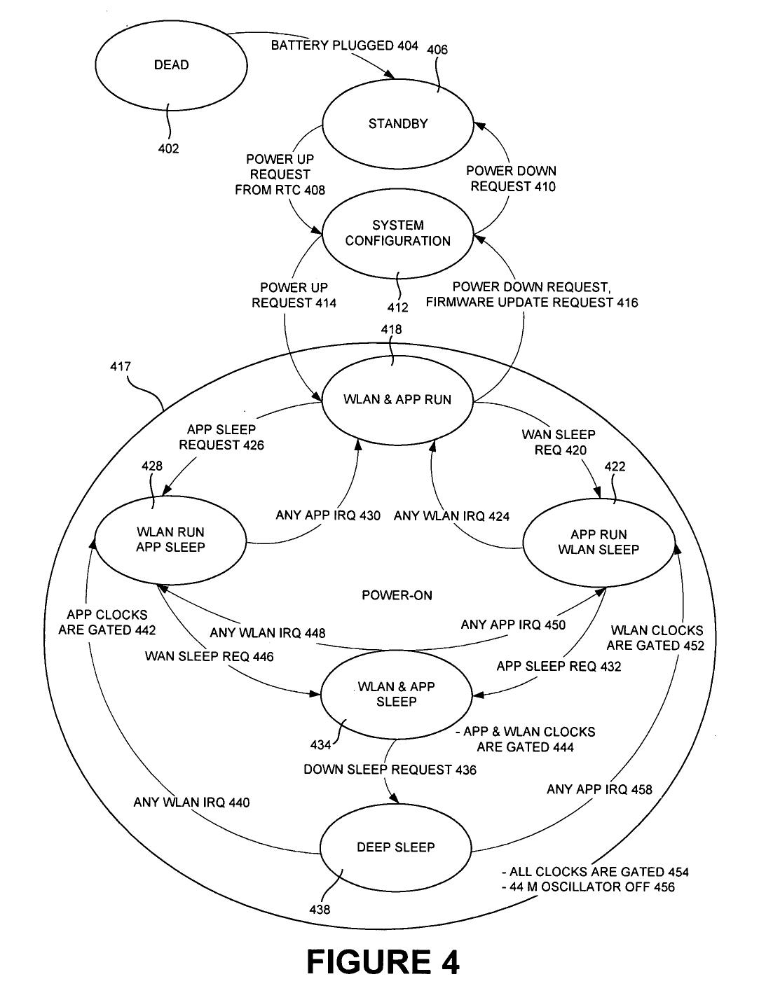

The interfaces may include support of an external serial E²PROM parameter memory and/or a serial flash data memory through a serial peripheral interface (SPI), two multi-purpose universal asynchronous receiver/transmitter (UART) interfaces 238, external CPU interfaces via SPI master 242 and SPI slave/GPI/O 244 interface, up to 32 General Purpose I/Os, three pulse-width modulated (PWM) function outputs 240, and I²C master and slave interface 236. The interfaces may also include support for two 10 bits 32K samples/ADC channels 234, two alarm inputs 230, three control outputs for power supply 228, external radio frequency (RF) switches/test 224, and support for external power amplifier, such as, dedicated transmitter (Tx) output 220 and PA digital-to-analog converter (DAC) output 222. The low power wireless SOC 200 may be connected to an antenna 218 to receive and/or transmit data to and/or from an access point. Along with low-power modes to be described in FIG. 4, the low power wireless SOC 200 may also have power supply monitoring and/or temperature monitoring capabilities. These features may help the device be alert for over and under voltage fault conditions.

Furthermore, a hardware module of the low power wireless SOC 200 (e.g. which includes one or more of a microcontroller, a microprocessor, a DSP core, a memory, a timing source, a peripheral, an external interface, etc.) has the real time counter (RTC) 208 of the peripheral isolated from a rest of the hardware module using more than one voltage level shifting cells and/or more than one voltage island cells (e.g., which is placed between the RTC 208 and the rest of the hardware module such that two different voltages are separately applied to the RTC 208 and the rest of the hardware module). Also, a software module (e.g., of the application platform 214) associated with the RTC 208 may generate one or more control signals to one or more devices external to the low power wireless SOC 200 during a sleep mode (e.g., the sleep mode places any unused part of the low power wireless SOC 200 in a non-operational mode to reduce power consumption) of the low power wireless SOC 200 to communicate with the one or more devices.

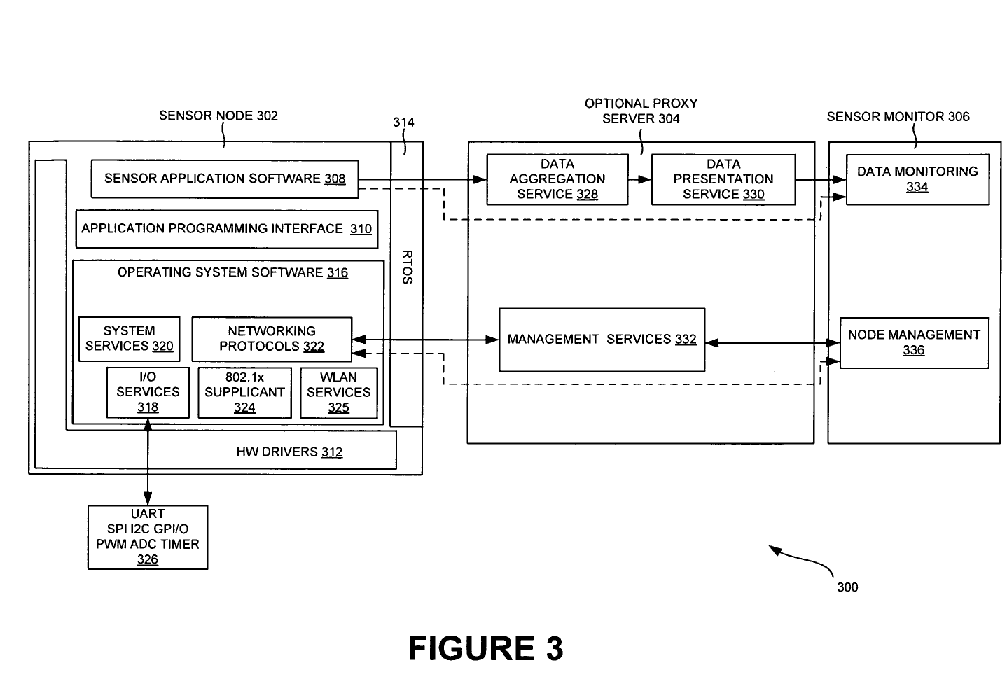

FIG. 3 is an interaction diagram of software modules of the low power wireless SOC of FIG. 2, according to one embodiment. A sensor node 302 may denote the location of a particular sensor (e.g., and/or other external devices) connected to the low power wireless SOC 200. The sensor node 302 may contain a sensor application software 308 which may be used to control the sensor (e.g., and/or other external devices) via a real-time operating system (RTOS) 314. The RTOS 314 may be a class of operating system intended for real-time applications. The RTOS 314 may operate on the hardware (HW) using hardware (HW) drivers 312. An operating system software 316, which may include system services 320, may act as an intermediary between the RTOS 314 and the HW drivers 312, networking protocols 322, a 802.1x supplicant 324, WLAN services 325 and I/O services 318 via a UART, SPI, I2C, GPIO, PWM, ADC, TIMER, etc. 326.

The sensor application software 308 may transmit the data to an optional proxy server304 which may be used to manage communication of data and/or operation commands between the sensor node 302 and the sensor monitor 306. In another example embodiment, the data may be transmitted directly from the sensor application software 308 to the sensor monitor 306 (e.g., thus not requiring the service of the optional proxy server 304). In the optional proxy server304, the data may be stacked in a data aggregation service 328 and/or may be organized and formatted in a data presentation service 330 so that it may be communicated to the sensor monitor 306. A management services module 332 in the optional proxy server304 may be used to manage communication between the sensor node 302 and the sensor monitor 306. The data may finally be presented to the data monitoring 334 module (e.g., in the sensor monitor 306) which performs data processing/analysis based on an operator and/or a software within the data monitoring module 334 to issue commands to the sensor node 302.

FIG. 4 is a state diagram of the low power wireless SOC 200 of FIG. 2, according to one embodiment. A dead state 402 may imply that no power source is connected to the system. When a battery 404 is plugged in, the real time clock (RTC) 208 may be powered up and the low power wireless SOC 200 makes a transition from the dead state 402 to a stand-by state 406. The RTC 208 may be supplied directly from a battery (e.g., a battery plugged 404). Here, the low power wireless SOC 200 may show the lowest power consumption. The stand-by state 406 may be entered between active phases. When a power up request 408 is made by the RTC module, the low power wireless SOC 200 makes a transition from the stand-by state 406 to a system configuration state 412.

To switch on the low power wireless SOC 200, a DC/DC converter (e.g., regulating a voltage input to the low power wireless SOC 200) needs to be on, the power isolation from the RTC 208 needs to be removed, and/or a 44 MHz oscillator needs to be switched on. In this state, only a reset of the WLAN subsystem may get released by the RTC 208. A WLAN CPU may execute required system configurations before the low power wireless SOC 200 moves on to a general operation state, through another power-up request 414 to switch to a power-on state 417. The system configuration state 412 may also make a transition from the power-on state 417 to the system configuration state 412 using a power-down request 416 and/or a firmware update request 416.

Another power-down request 410 may be made to make a transition from the system configuration state 412 to the stand-by state 406. The power-on state 417 may be an active state where the low power wireless SOC 200 is running. The power-on state 417 may have various sub-states, when unused parts of the system may be programmed to be in a non-operational mode reducing power consumption. These sub-states may be combined in a sleep state, which may be generically defined as a low-power condition. The several sub-states of sleep (e.g., the APP RUN WLAN SLEEP 422, the WLAN RUN APP SLEEP 428, THE WLAN & APP SLEEP 434, and THE DEEP SLEEP 438) may result in several scenarios as can be observed in FIG. 4.

The common characteristic of the sleep states may be that both the system voltage and the system clock are available, but the clock to specific parts of the system may be gated. For instance, one of the processors might be in a wireless fidelity (Wi-Fi) mode with its clock gated, while the other processor may be running. The system may be in a deep-sleep state 438 when all parts of the core system are in a sleep state and the 44 MHz oscillator may be switched off. Furthermore, the low power wireless SOC 200 of FIG. 2 draws about 3 micro amps during the deep-sleep state compared to 300 mili-amps drawn by the low power wireless SOC 200 when the rest of the hardware module is operational.

FIG. 5 is a low power wireless system on chip (SOC) 500 interacting with a host server 534 through an access point 526, according to one embodiment. An antenna 502 may be used to receive and/or transmit a true signal 536 (e.g., data) to and/or from the access point 526 (e.g., the gateway 110 of FIG. 1). A 32 kHz/131 kHz low-power crystal oscillator 504 may be used to drive a real time counter (RTC) 514 and a 44 MHz oscillator 508 may be used to drive a WLAN 510 and application (APP) CPUs. A flash memory 540 and a SRAM 538 may be used for a firmware update and/or a key management in encryption/decryption cores. The RTC 514 may be also used to provide global time and date to the low power wireless SOC 500 (e.g., which may have a dedicated power supply). The low power wireless SOC 500 may be connected to two sensor devices (e.g., a sensor 1 518 and a sensor 2 520) via an I/O interface 516. The low power wireless SOC 500 may be also powered by a battery 524 via a DC/DC converter 522 which converts the battery voltage to 1.8 V required for the operation of the low power wireless SOC 500.

In FIG. 5, data communication may take place between the sensors and the AP 526 via the low power wireless SOC 500 (e.g., which is compliant with the IEEE 802.11). The AP 526 may be connected via a network 528 to an authentication server 530 (e.g., which may be used to provide authentication services to the host server 534, a optional proxy server 532, etc.).

Furthermore, one or more external devices (e.g., the sensor 1 518, the sensor 2 520, etc.) may perform one or more functions based on a control signal processed in each of the one or more external devices. The low power wireless SOC 500 having the RTC 514 (e.g., which is communicatively coupled to the one or more external devices) may periodically generate the control signal. In addition, the WLAN 510 may communicate with the access point (AP) 526 using a radio (e.g., conforming to 802.11 a/b/g standard) based on an alarm signal generated by the each of the one or more external devices.

In one example embodiment, a chatter signal (e.g., the chatter signal 538) generated by a first node (e.g., the sensor 1 518 and/or the sensor 2 520 coupled to the low power wireless SOC 502) of a network (e.g., the network 528) may be communicated to a second node (e.g., the host server 534 which may include a control point—a protocol, and/or an algorithm that may direct an operation of the host server to nodes and/or devices of the network and the network's other resources, and/or to enable communication to other control points in the network) based on a communication protocol of the network to guise a true signal (e.g., the true signal 536) of the fist node communicated to the second node of the network.

Also, the true signal communicated to the second node may be processed while dispensing with the chatter signal (e.g., which may include encrypted pseudorandom bits to be decrypted by the second node based on the communication protocol) communicated to the second node based on the communication protocol of the network. A heartbeat signal of the device communicated to the control point may be guised with the chatter signal (e.g., where the true signal may be the heartbeat signal of the device communicated to the control point indicating that the device is ready to communicate with the control point). A signal data (e.g., which may be a configuration data to set up the device and/or a command data to initiate an action by the device) of the control point to the device may be guised with the chatter signal.

In another example embodiment, the chatter signal and/or the true signal may be padded with pseudorandom bits to make a size of the chatter signal equal to a size of the true signal. Also, a random number of bits may be added to the chatter signal and/or the true signal such that the size of the chatter signal and the size of the true signal are random. Furthermore, a key exchanged between the first node and the second node (e.g., based on the Diffie-Hellman key exchange scheme) may be guised with the chatter signal (e.g., where the true signal to convey the key exchanged between the first node and the second node preceding a secure communication between the first node and the second node).

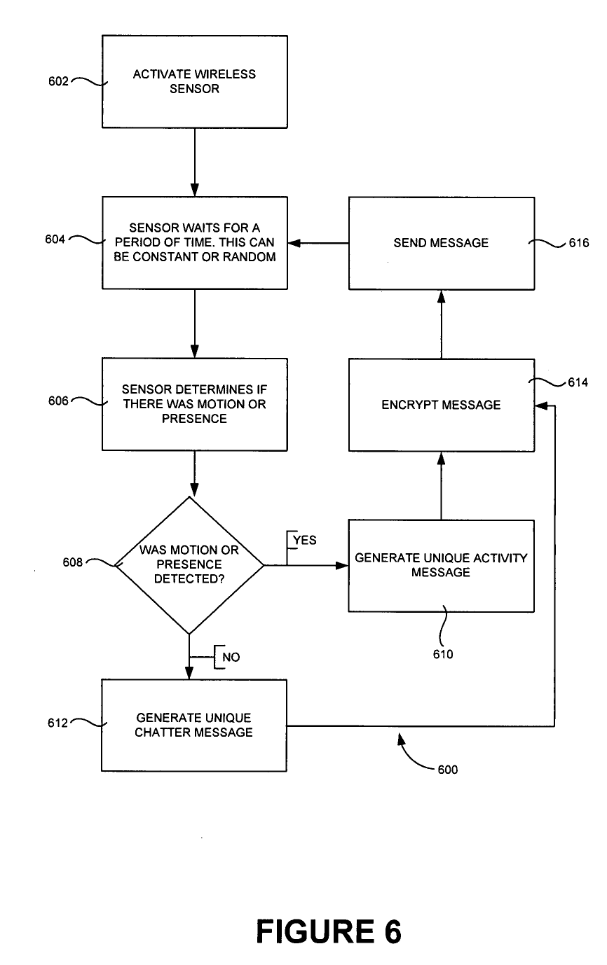

FIG. 6 is a state flow diagram 600 of disguising an activity signal of a wireless motion sensor with one or more chatter signals, according to one embodiment. In operation 602, a wireless motion sensor may be activated (e.g., through registering with a control point managing the wireless motion sensor). In operation 604, the wireless motion sensor may wait for a period of time. The period may be constant or change randomly. In operation 606, the wireless motion sensor may monitor for motion. When the wireless motion sensor decides that the motion (e.g., and/or a presence of a moving object) is detected in operation 608, the wireless motion sensor may generate an activity message (e.g., activity data) in operation 610.

When the motion is not detected in operation 608, the wireless motion sensor may generate a chatter message (e.g., a chatter signal) in operation 612. When the activity message is generate in operation 610 and/or the chatter message is generated in operation 612, the activity message and/or the chatter message may be encrypted in operation 614. Once the encryption is completed, the activity message and/or the chatter message may be communicated to a target device in operation 616.

In one example embodiment, a motion may be monitored using a wireless motion sensor (e.g., the sensor 1 112B of FIG. 1) to generate an activity signal (e.g., or the activity message) when the motion is detected by the wireless motion sensor. One or more chatter signals (e.g., periodic or aperiodic chatter message) may be communicated to disguise the activity signal communicated to a control point (e.g., the controller 106B) managing the wireless motion sensor through a wireless network (e.g., the network 108B). The wireless motion sensor may be locally controlled by a low power wireless system on chip (SOC) (e.g., the low power wireless SOC 1 114B) having a real time counter module communicatively coupled to the wireless motion sensor to periodically generate the true signal and/or the chatter signal to minimize a power consumption of the low power wireless system on chip (SOC).

In another example embodiment, the chatter signal and/or the activity signal may be padded with pseudorandom bits such that the chatter signal may not be recognizable from the activity signal based on a size difference between the chatter signal and the activity signal. The chatter signal and/or the activity signal may be encrypted prior to communicating the chatter signal and/or the activity signal to the control point. Additionally, the chatter signal may be dispensed with when the control point decrypts the activity signal and/or the chatter signal to process the activity signal.

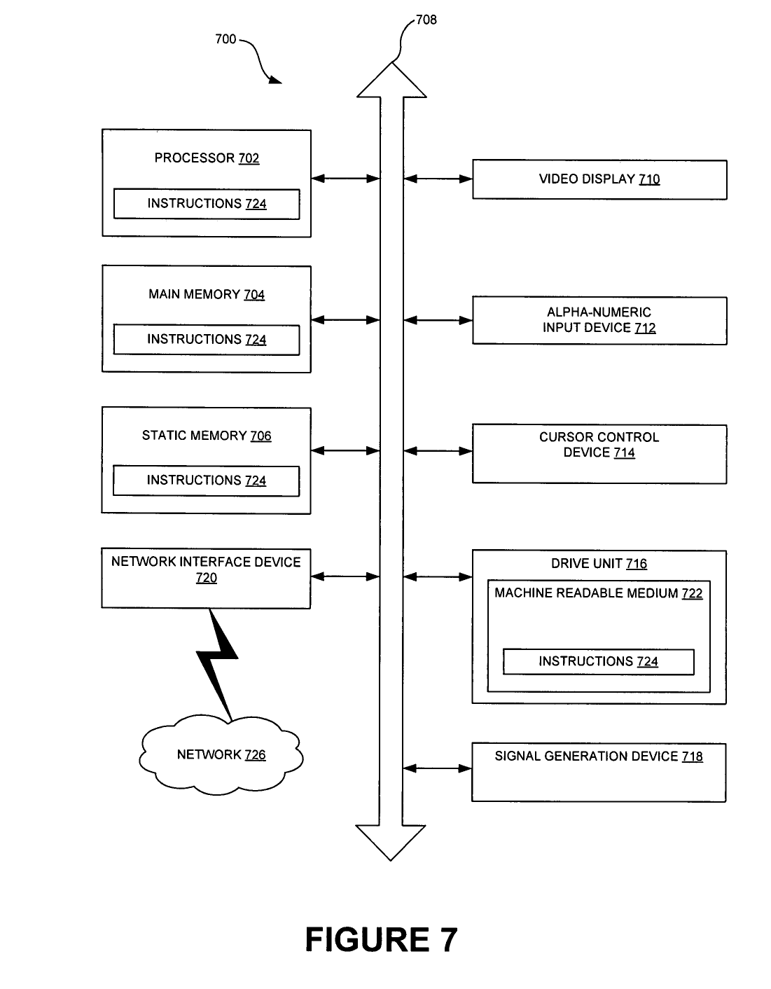

FIG. 7 is a diagrammatic representation of a computer system 700 capable of processing a set of instructions to perform any one or more of the methodologies herein, according to one embodiment. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment.

The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 700 includes a processor 702 (e.g., a central processing unit (CPU) a graphics processing unit (GPU) and/or both), a main memory 704 and a static memory 706, which communicate with each other via a bus 708. The computer system 700 may further include a video display unit 710 (e.g., a liquid crystal display (LCD) and/or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies and/or functions described herein. The software 724 may also reside, completely and/or at least partially, within the main memory 704 and/or within the processor 702 during execution thereof by the computer system 700, the main memory 704 and the processor 702 also constituting machine-readable media.

The software 724 may further be transmitted and/or received over a network 726 via the network interface device 720. While the machine-readable medium 722 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Although the present embodiments have been described with reference to specific example embodiments, it will be evident that various modifications and changes may be made to these embodiments without departing from the broader spirit and scope of the various embodiments. For example, the various devices, modules, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

Also, the method may be in a form of a machine-readable medium embodying a set of instructions that, when executed by a machine, cause the machine to perform any method disclosed herein. It will be appreciated that the various embodiments discussed herein may/may not be the same embodiment, and may be grouped into various other embodiments not explicitly disclosed herein.

in addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
communicating a chatter signal generated by a first node of a network to a second node based on a communication protocol of the network to guise a true signal of the fist node communicated to the second node of the network; and
processing the true signal communicated to the second node while dispensing with the chatter signal communicated to the second node based on the communication protocol of the network.

2. The method of claim 1, wherein the chatter signal includes encrypted pseudorandom bits to be decrypted by the second node based on the communication protocol.

3. The method of claim 1, wherein the first node is a device and the second node is a control point managing the device.

4. The method of claim 3, further comprising guising a heartbeat signal of the device communicated to the control point with the chatter signal, wherein the true signal is the heartbeat signal of the device communicated to the control point indicating that the device is ready to communicate with the control point.

5. The method of claim 4, further comprising guising a signal data of the control point to the device with the chatter signal, wherein the signal data is at least one of a configuration data to set up the device and a command data to initiate an action by the device.

6. The method of claim 5, wherein the device to include a low power wireless system on chip (SOC) having a real time counter module communicatively coupled to the device to generate at least one of the true signal and the chatter signal to minimize a power consumption of the low power wireless system on chip (SOC).

7. The method of claim 1, further comprising padding at least one of the chatter signal and the true signal with pseudorandom bits to make a size of the chatter signal equal to a size of the true signal.

8. The method of claim 7, wherein a random number of bits are added to the at least one of the chatter signal and the true signal such that the size of the chatter signal and the size of the true signal are random.

9. The method of claim 1, further comprising guising a key exchanged between the first node and the second node with the chatter signal, wherein the true signal to convey the key exchanged between the first node and the second node preceding a secure communication between the first node and the second node.

10. The method of claim 1 in a form of a machine-readable medium embodying a set of instructions that, when executed by a machine, causes the machine to perform the method of claim 1.

11. A method, comprising:
monitoring a motion using a wireless motion sensor to generate an activity signal when the motion is detected by the wireless motion sensor; and
communicating at least one chatter signal to disguise the activity signal communicated to a control point managing the wireless motion sensor through a wireless network.

12. The method of claim 11, wherein the wireless motion sensor is locally controlled by a low power wireless system on chip (SOC) having a real time counter module communicatively coupled to the wireless motion sensor to periodically generate at least one of the true signal and the chatter signal to minimize a power consumption of the low power wireless system on chip (SOC).

13. The method of claim 11, wherein the chatter signal is at least one of a periodic signal and an aperiodic signal.

14. The method of claim 11, further comprising padding at least one of the chatter signal and the activity signal with pseudorandom bits such that the chatter signal is not recognizable from the activity signal based on a size difference between the chatter signal and the activity signal.

15. The method of claim 14, further comprising encrypting the at least one of the chatter signal and the activity signal prior to communicating the at least one of the chatter signal and the activity signal to the control point.

16. The method of claim 15, further comprising dispensing with the chatter signal when the control point decrypt the at least one of the activity signal and the chatter signal to process the activity signal.

17. A system, comprising:
a first node of a network to generate at least one chatter signal with a true signal to disguise the true signal; and
a second node to communicate with the first node through processing the true signal while dispensing with the at least one chatter signal.

18. The system of claim 17, wherein the first node is a device and the second node is a control point managing the device through a network.

19. The system of claim 18, further comprising a low power wireless system on chip (SOC) having a real time counter module communicatively coupled to the device to periodically generate at least one of the true signal and the at least one chatter signal to minimize a power consumption of the low power wireless system on chip (SOC).

20. The system of claim 17, wherein the first node is a device newly installed to a network and the second node is an authentication server to authenticate the device based on the true signal which is an authentiation request of the device communicated to the authentication server.
